(19) United States
(12) Patent Application Publication
(10) Pub. No.: US 2005/0255008 A1
(43) Pub. Date: Nov. 17, 2005

(54) Portable fragrance disperser

(76) Inventor: Hao-Cheng Lin, Taipei City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/827,816

(22) Filed: Apr. 20, 2004

(51) Int. Cl. A62B 7/08

(52) U.S. Cl. 422/124; 422/123

(57) ABSTRACT

A portable fragrance disperser adapted for use with a fragrance cartridge includes a housing, a fan unit, and an air guide assembly. The housing is formed with a component containing space, and has a fragrance inlet, a fragrance outlet and an air inlet, all of which are in fluid communication with the component containing space. The fragrance inlet is adapted to engage the fragrance cartridge. The fan unit is mounted in the component containing space, and is operable so as to mix air flowing into the housing via the air inlet with the scent of the fragrant material coming from the fragrance inlet to result in a fragrant air stream that is released at the fragrance outlet. The air guide assembly includes a guide tube coupled to the housing at the fragrance outlet for guiding flow of the fragrant air stream released from the housing.

### BACKGROUND OF THE INVENTION

1. Field of the Invention

The invention relates to a fragrance disperser, more particularly to a portable fragrance disperser.

2. Description of the Related Art

Aromatherapy involves exposure to aromatic scents for relaxation and stress-reduction. As aromatherapy has become fashionable, various apparatus for dispersing aroma are widely available nowadays. Conventional aroma or fragrance dispersers release fragrance into the atmosphere through various methods, such as vaporization by heating using a candle or an electric heat source, excitation to oscillate water molecules, etc. Aside from the fact that the conventional fragrance dispersers are generally designed for stationary placement in a certain place during use and are not designed to be carried around when dispersing fragrance, other drawbacks are encountered. For instance, a long period of operation is required to saturate an enclosed area with fragrance. Moreover, the fragrant source, which is expensive, is easily and inefficiently consumed.

### SUMMARY OF THE INVENTION

Therefore, the object of the present invention is to provide a portable fragrance disperser that can overcome the aforesaid drawbacks of the prior art.

Accordingly, the portable fragrance disperser of this invention is adapted for use with a fragrance cartridge that contains a fragrant material and that has a neck portion for releasing scent of the fragrant material. The portable fragrance disperser comprises a housing, a fan unit, and an air guide assembly. The housing is formed with a component containing space, and has a fragrance inlet, a fragrance outlet and an air inlet, all of which are in fluid communication with the component containing space. The fragrance inlet is adapted to engage the neck portion of the fragrance cartridge. The fan unit is mounted in the component containing space, and is operable so as to mix air flowing into the housing via the air inlet with the scent of the fragrant material coming from the fragrance inlet to result in a fragrant air stream that is released at the fragrance outlet. The air guide assembly includes a guide tube coupled to the housing at the fragrance outlet for guiding flow of the fragrant air stream released from the housing.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a portable fragrance disperser according to the present invention;

FIG. 2 is a partly sectional, schematic front view of the preferred embodiment; and

FIG. 3 is a fragmentary, partly sectional, schematic side view of the preferred embodiment.

### DETAILED DESCRIPTION OF THE PREFERRED EMBODIMENT

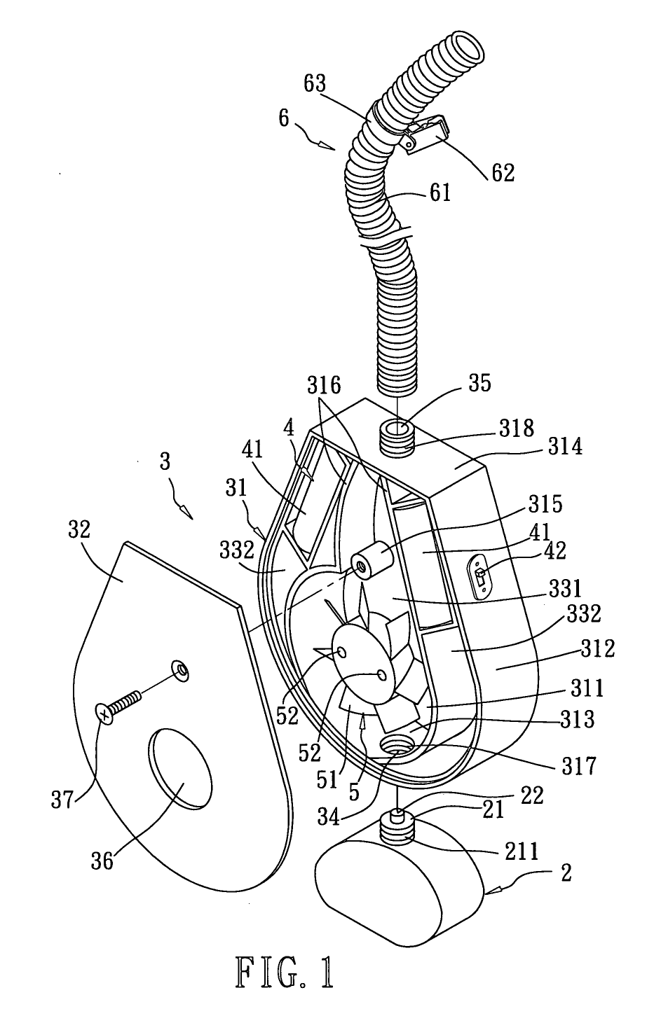

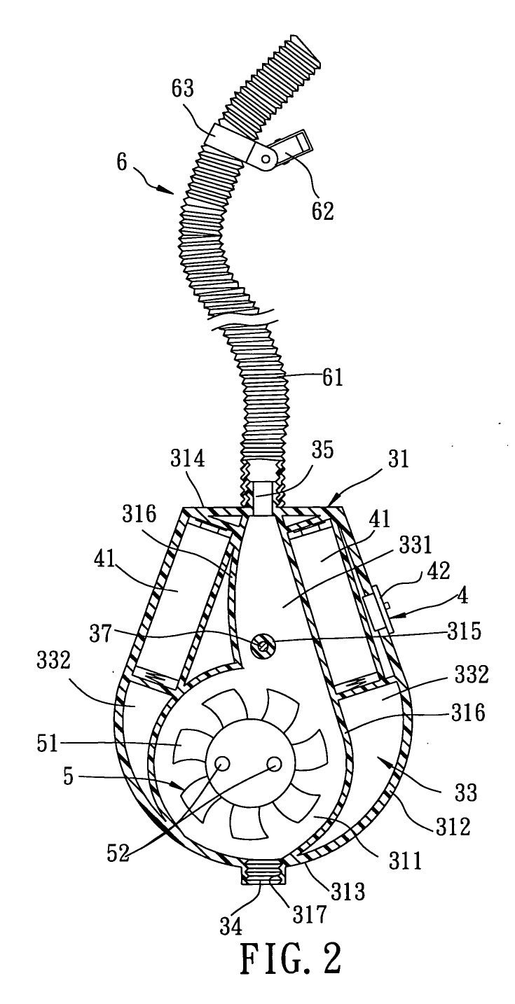

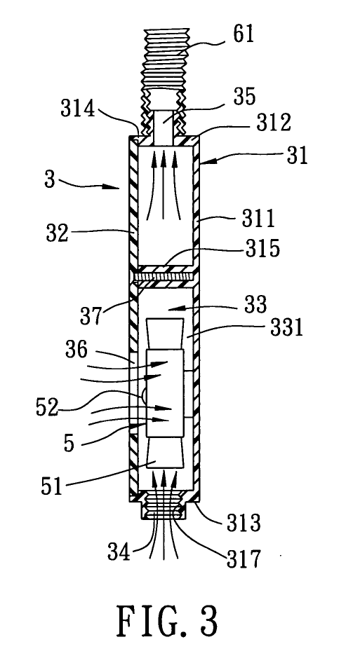

Referring to FIGS. 1 to 3, the preferred embodiment of a portable fragrance disperser according to the present invention is shown to be adapted for use with a fragrance cartridge 2. The fragrance cartridge 2 contains a fragrant material (not shown), which can be in liquid, semi-solid or solid form, and has a neck portion 21 that is formed with an external screw thread 211 and that is configured for releasing scent of the fragrant material. When the fragrant material is in liquid or semi-solid form, the neck portion 21 of the fragrance cartridge 2 may be provided with a wick 22 to control the release of the scent of the fragrant material from the fragrance cartridge 2.

The portable fragrance disperser of this embodiment comprises a housing 3, a fan unit 5, a power supply unit 4, and an air guide assembly 6.

The housing 3 includes a hollow housing part 31 and a cover part 32. The hollow housing part 31 includes a base plate 311, and a peripheral wall 312 extending from a periphery of the base plate 311 and cooperating with the base plate 311 to define a component containing space 33. The peripheral wall 312 has upper and lower wall portions 314, 313 respectively formed with a fragrance outlet 35 and a fragrance inlet 34 that are in fluid communication with the component containing space 33. The base plate 311 is further formed with a mounting post 315 that extends toward the cover plate 32. The fragrance inlet 34 is formed with an internal screw thread 317, and is adapted to engage the external screw thread 211 of the neck portion 21 of the fragrance cartridge 2. The fragrance outlet 35 is formed with an external screw thread 318. The housing part 31 further includes a partition unit 316 extending from the base plate 311 so as to partition the component containing space 33 into a fan chamber 331 for containing the fan unit 5 and that is in fluid communication with the fragrance inlet 34 and the fragrance outlet 35, and a power chamber 332 that includes two compartments disposed on opposite sides of the fan chamber 331 for containing the power supply unit 4. In this embodiment, the fan chamber 331 is configured with a narrower upper portion in fluid communication with the fragrance outlet 35, and a wider lower portion in fluid communication with the fragrance inlet 34. The cover part 32 is mounted removably on the housing part 31 to close one side of the component containing space 33 opposite to the base plate 311. In this embodiment, the cover part 32 is fastened to the housing part 31 by a fastener 37 that engages the mounting post 315. The cover part 32 is formed with an air inlet 36 that is in fluid communication with the fan chamber 331 of the component containing space 33. In this embodiment, the air inlet 36 is registered with the wider lower portion of the fan chamber 331, and is thus disposed closer to the fragrance inlet 34 than the fragrance outlet 35.

The fan unit 5 is mounted in the wider lower portion of the fan chamber 331 of the component containing space 33, and is operable so as to mix air flowing into the housing 3 via the air inlet 36 with the scent of the fragrant material coming from the fragrance inlet 34 to result in a fragrant air stream that is released at the fragrance outlet 35. The fan unit 5 includes a fan impeller 51 and a set of light-emitting components 52, such as light-emitting diodes, mounted on the fan impeller 51. Preferably, the air inlet 36 is registered with the fan impeller 51 such that light generated by the light-emitting components 52 during operation of the fan unit 5 can radiate out of the housing 3 to indicate operating status of the fan unit 5 and to generate an appealing visual effect.

The power supply unit 4 is coupled electrically to and controls operation of the fan unit 5. In this embodiment, the power supply unit 4 includes two battery cells 41 that are connected in series. Each of the battery cells 41 is received removably in a respective one of the compartments of the power chamber 332 of the component containing space 33. The power supply unit 4 further includes a slide switch 42 mounted on the peripheral wall 312 of the housing part 31 and operable so as to control supply of electric power from the battery cells 41 to the fan unit 5.

The air guide assembly 6 includes a guide tube 61, a clasp 63, and a clip 62. The guide tube 61, which is a flexible bellows tube in this embodiment, is coupled to the housing 3 at the fragrance outlet 35 for guiding flow of the fragrant air stream released from the housing 3. In this embodiment, the guide tube 61 has an internally threaded end to engage the external screw thread 318 of the fragrance outlet 35. The clasp 63 is sleeved on the guide tube 61. The clip 62 is mounted on the clasp 63, and can be used to clip an object, such as an article of clothing.

In use, the housing 3 engages the fragrance cartridge 2, and the housing 3 and the fragrance cartridge 2 are subsequently placed in an air-permeable carrying pouch or container. The clip 62 is then operated to clip an article of clothing of the user such that the guide tube 61 can be held close to the user's nostrils. When the switch 42 is turned on, the fan unit 5 is activated for mixing air that flows into the housing 3 via the air inlet 36 with the scent of the fragrant material coming from the fragrance inlet 34 to result in the fragrant air stream that is released at the fragrance outlet 35 and that is guided to the user's nostrils by the guide tube 61.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A portable fragrance disperser adapted for use with a fragrance cartridge, the fragrance cartridge containing a fragrant material and having a neck portion for releasing scent of the fragrant material, said portable fragrance disperser comprising:
a housing formed with a component containing space, and having a fragrance inlet, a fragrance outlet and an air inlet, all of which are in fluid communication with said component containing space, said fragrance inlet being adapted to engage the neck portion of the fragrance cartridge;
a fan unit mounted in said component containing space and operable so as to mix air flowing into said housing via said air inlet with the scent of the fragrant material coming from said fragrance inlet to result in a fragrant air stream that is released at said fragrance outlet; and
an air guide assembly including a guide tube coupled to said housing at said fragrance outlet for guiding flow of the fragrant air stream released from said housing.

2. The portable fragrance disperser as claimed in claim 1, further comprising a power supply unit mounted in said component containing space and coupled electrically to and controlling operation of said fan unit.

3. The portable fragrance disperser as claimed in claim 2, wherein said power supply unit includes at least one battery cell.

4. The portable fragrance disperser as claimed in claim 3, wherein said housing includes:
a hollow housing part including a base plate and a peripheral wall extending from a periphery of said base plate and cooperating with said base plate to define said component containing space, said peripheral wall being formed with said fragrance inlet and said fragrance outlet; and
a cover part mounted removably on said hollow housing part to close one side of said component containing space opposite to said base plate, said cover part being formed with said air inlet.

5. The portable fragrance disperser as claimed in claim 4, wherein said peripheral wall has upper and lower wall portions formed with said fragrance outlet and said fragrance inlet, respectively.

6. The portable fragrance disperser as claimed in claim 5, wherein said air inlet is disposed closer to said fragrance inlet than said fragrance outlet.

7. The portable fragrance disperser as claimed in claim 4, wherein said hollow housing part further includes a partition unit extending from said base plate for partitioning said component containing space into a power chamber that contains said power supply unit, and a fan chamber that contains said fan unit and that is in fluid communication with said fragrance inlet, said fragrance outlet and said air inlet.

8. The portable fragrance disperser as claimed in claim 7, wherein said power chamber includes two compartments disposed on opposite sides of said fan chamber, said power supply unit including two of said battery cells, each of which is received removably in a respective one of said compartments of said power chamber.

9. The portable fragrance disperser as claimed in claim 4, wherein said power supply unit further includes a switch mounted on said peripheral wall of said hollow housing part and operable so as to control supply of electric power from said at least one battery cell to said fan unit.

10. The portable fragrance disperser as claimed in claim 7, wherein said fan chamber has a narrower upper portion in fluid communication with said fragrance outlet, and a wider lower portion in fluid communication with said fragrance inlet, said fan unit being disposed in said wider lower portion of said fan chamber.

11. The portable fragrance disperser as claimed in claim 10, wherein said air inlet is registered with said wider lower portion of said fan chamber.

12. The portable fragrance disperser as claimed in claim 1, wherein said fragrance inlet is formed with an internal screw thread.

13. The portable fragrance disperser as claimed in claim 1, wherein said fragrance outlet is formed with an external screw thread, said guide tube having an internally threaded end to engage said external screw thread of said fragrance outlet.

14. The portable fragrance disperser as claimed in claim 1, wherein said guide tube is a flexible tube.

15. The portable fragrance disperser as claimed in claim 14, wherein said air guide assembly further includes a clasp sleeved on said guide tube, and a clip mounted on said clasp.

16. The portable fragrance disperser as claimed in claim 1, wherein said fan unit includes a fan impeller and a light emitting component mounted on said fan impeller, said air inlet being registered with said fan impeller.
